(19) United States
(12) Patent Application Publication
(10) Pub. No.: US 2011/0216533 A1
(43) Pub. Date: Sep. 8, 2011

(54) ELECTRONIC GLOW STICK DEVICE WITH ALTERNATING FLASHER

(75) Inventor: Dennis Bertken, Solana Beach, CA (US)

(73) Assignee: LIFE+GEAR, INC., Solana Beach, CA (US)

(21) Appl. No.: 12/716,194

(22) Filed: Mar. 2, 2010

(51) Int. Cl. F21L 4/04; F21V 15/00

(52) U.S. Cl. 362/205; 362/362

(57) ABSTRACT

A lighting device including an elongate illuminated portion having translucent side walls spaced about a long axis of the illuminated portion. The device further includes a light source configured to direct light along a length of the illuminated portion and out the translucent side walls. An actuator extends in a biased position oppositely from the light source in a deactivated position. A circuit is electrically coupled between the actuator and light source for activating the light to a first lighting function for so long as the actuator is moved to a compressed position, detecting the actuator being moved back to its biased position, and activating the light to a second lighting function for so long as the actuator is moved back to the compressed position.

### BACKGROUND OF THE INVENTION

This invention relates generally to lighting sources and more particularly to a light source with flasher and glow stick function.

Portable lighting is typically designed with the task in mind. Accordingly, flashlights are designed to focus a beam of light for peering into dark corners or cast light longer distances whereas lanterns are designed to cast light short distances but in all directions. One such general lighting source is the chemical-based glow stick. The glow stick embeds two or more chemicals within a hollow plastic tube that, when combined, fluoresce for a brief period of time along the length of the tube. To use the glow stick, the tube is bent so that a capsule containing one of the chemicals is broken. The tube is shaken to mix the two chemicals and start the fluorescence process. Light from this process is radiated out the sidewalls of the tube in all directions.

One disadvantage of chemical-based glow sticks is that they are unable to selectively turn off once activated other than the slow decay of light output over time once the chemical reaction causing fluorescence decreases and stops. Furthermore, such chemical-based devices are unable to flash in an off-on-off-on state, and thus may not confer as much safety advantage as a flashing light.

There is thus a desire to provide a glow stick-like device with the ability to glow and/or flash along a length of the lighting source.

### SUMMARY OF THE INVENTION

In various representative aspects, the present invention describes an elongated lighting device.

A lighting device, constructed according to the invention, comprises a module having a light source at one end of the module and a power source and an actuator biased in an extended position on a surface of the module. The lighting device further includes an elongate glow stick housing comprising an end cap and an illuminated portion coupled together to form a cavity. The module is received within the cavity so that the light source is directed along an axis of the illuminated portion. Further, the end cap and illuminated portion are configured to be moveable relative to one another so as to change an axial length of the cavity, and a surface of the illuminated portion is configured to be moveable against the module so as selectively compress the actuator to a compressed position. In this configuration, the light source is activated when the actuator is in one of the extended position or compressed position, and the light source is deactivated when the actuator is in the other of the extended position or compressed position.

In another implementation of the invention, the lighting device comprises an elongate illuminated portion having translucent side walls spaced about a long axis of the illuminated portion. A light source is configured to direct light along a length of the illuminated portion and out the translucent side walls. An actuator extends in a biased position oppositely from the light source in a deactivated position. Further, a circuit is electrically coupled between the actuator and light source for activating the light to a first lighting function for so long as the actuator is moved to a compressed position, detecting the actuator being moved back to its biased position, and activating the light to a second lighting function for so long as the actuator is moved back to the compressed position.

In yet another implementation of the invention, the lighting device comprises a module having a light source at one end of the module and a power source. An actuator is positioned on a surface of the module opposite the light source for activating the light source. The lighting device further includes an elongate glow stick housing comprising an end cap and an illuminated portion coupled together, the module received within the end cap so that the light source is directed along a long axis of the illuminated portion. The illuminated portion has translucent side walls spaced about the long axis of the illuminated portion, where the side walls taper to a distal end of the illuminated portion so that side walls proximal to the end cap have a first diameter and the side walls distal to the end cap having a second diameter, wherein the second diameter is less than the first diameter so that the side walls move inwardly toward the long axis of the illuminated portion as they extend from the end cap.

The invention also includes a method for configuring an electronic glowstick lighting device having an elongate illuminated portion coupled along an axial length of the electronic glowstick to an end cap. The method comprises installing an integrated module within a cavity formed by the illuminated portion and end cap, where the integrated module has a light source at one end directing light along the illuminated portion and an actuator at the other end of the integrated module with a power source located between the light source and actuator. The actuator is in an extended, deactivated position, and is adapted to be forced during operation of the lighting device against a wall of the cavity to a compressed position and maintained in the compressed position. Movement of the actuator to the compressed position is detected and, responsive to this detection, the light source of the lighting device is activated in a first lighting function for so long as the actuator is in the compressed position. Movement of the actuator to an extended position is then detected and, responsive to this detection, the light source is deactivated.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a partial perspective view of a lighting device constructed according to a preferred embodiment of the invention.

FIG. 2 is a partial exploded view of the lighting device of FIG. 1.

FIG. 3A is a section side-elevation view taken along line 3-3 in FIG. 1 illustrating the lighting device in a deactivated position.

FIG. 3B is a section side-elevation view taken along line 3-3 in FIG. 1 illustrating the lighting device in an activated position.

FIG. 4 is a section end-elevation view taken along line 4-4 in FIG. 1. FIG. 5 is a flow-chart illustrating the function of the lighting module upon successive activations and deactivations of the actuator.

FIG. 6 is a perspective view of a lighting module of the invention configured according to an alternate embodiment of the invention.

FIGS. 7A and 7B are section side-elevation views illustrating the lighting module in deactivated and activated modes, respectively, when installed within the lighting device of FIG. 1.

FIG. 8 is an examplary circuit diagram enabling operation of the lighting device.

### DETAILED DESCRIPTION

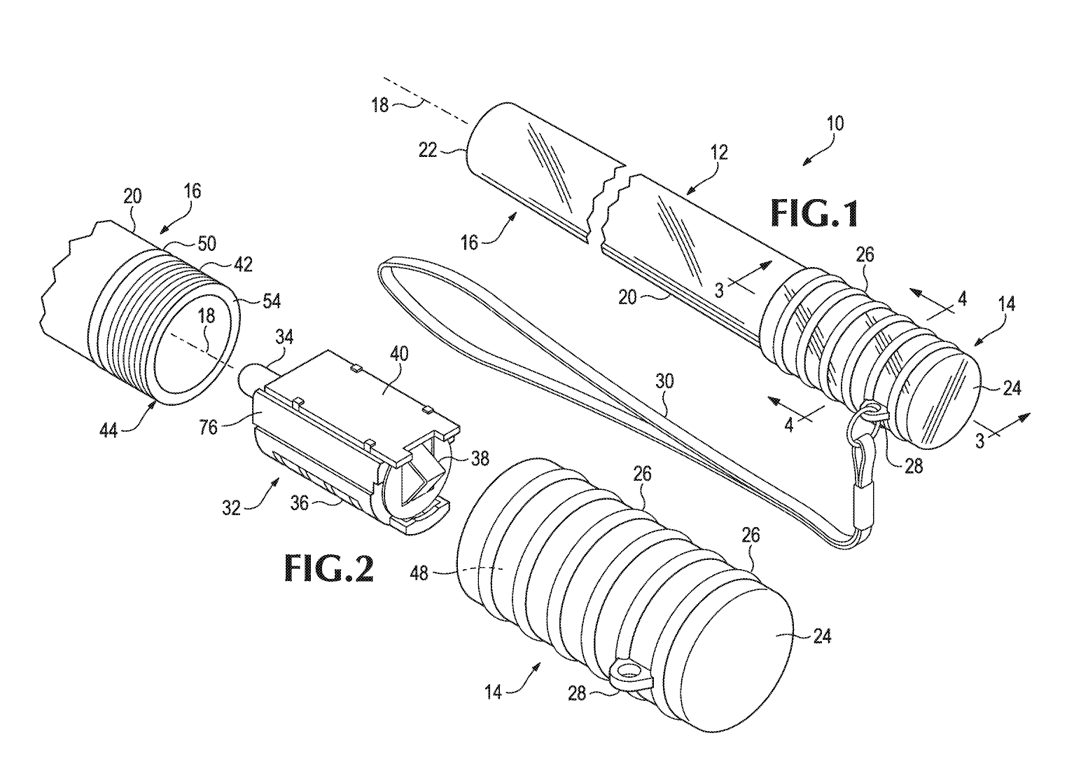

FIG. 1 illustrates a lighting device 10 implemented according to a preferred embodiment of the invention. Device 10 includes an elongate glowstick housing 12, having an end cap 14 coupled to an illuminated portion 16.

In the embodiment shown, lighting device 10 has a generally tubular shape extended along a long axis 18 of the device. Illuminated portion 16 includes annular and translucent side walls 20 spaced about the long axis 18 that taper toward a distal end 22. In this fashion, side walls 20 proximal end cap 14 have a first diameter while side walls distal to the end cap have a second diameter, less than the first diameter, so that the side walls move inwardly toward long axis 18 as they extend from the end cap.

End cap 14, like illuminated portion 16, includes annular side walls terminating at one end at an outer wall 24, disposed generally perpendicular to the long axis of the device 10, so as to form a hollow cylinder. As will be appreciated from the discussion below, the end cap and illuminated portion are coupled together so as to form a cavity to hold and maintain electronics for operating the lighting device. The end cap can further include multiple decorative annular ribs 26 formed on its side walls, a pierced flange 28, and a lanyard or wrist-strap 30 attached to the flange 28.

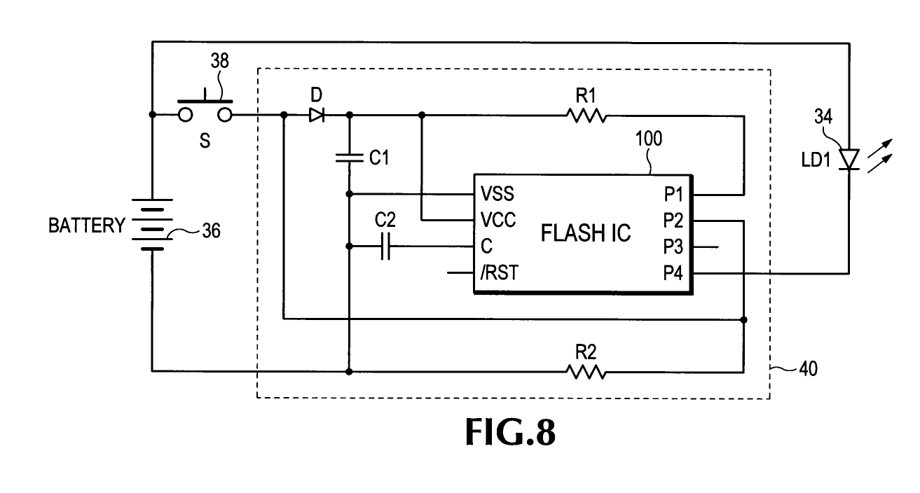

FIG. 2 shows in perspective a lighting module 32 exploded from the end cap 14 and a proximal portion of the illuminated portion 16. Module 32 includes a light source, characterized by LED 34, at one end of the module, a power source, characterized by a set 36 of three 1.5 volt batteries, and an actuator 38 for electrically coupling the power source to the light source and thereby activating the light source. Module 32 further includes a circuit 40—such as the circuit shown in FIG. 8—that is operative in a preferred embodiment to alternate between a first lighting function and a second lighting function as the light source is activated, then deactivated, and then activated again. In one example, the first lighting function is activation of LED 34 to yield a constant light source, while the second lighting function is activation of LED 34 to yield a flashing light source.

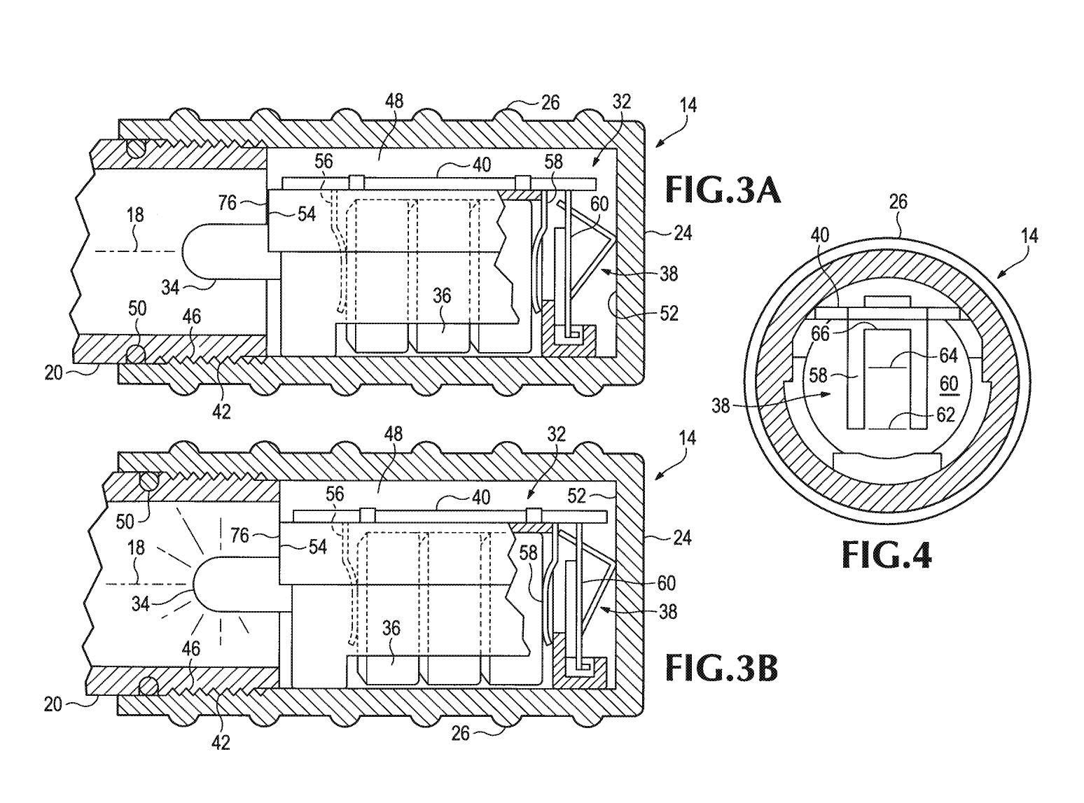

Illuminated portion 16 includes annular threads 42 formed exteriorly on side walls 20 adjacent a proximal end 44 of the illuminated portion 16. Complementary threads 46 (FIGS. 3A and 3B) are formed interiorly of side surfaces of the end cap 14 and mate with threads 42 so that illuminated portion 16 and end cap 14 may be threadedly coupled together to form a cavity 48 therewithin. Module 32 is adapted to be received within cavity 48 so that the light source 34 is directed along the long axis 18 of the illuminated portion 16 and, by internal reflection and diffusion, out the translucent side walls 20 so that the lighting device effects an elongated glowing tube for safety and/or general lighting purposes. An o-ring 50 is placed distally of the threads 42 on illuminated portion 16 and serves to seal the cavity 48 from water.

FIGS. 3A and 3B illustrate side-elevation views of the module 32 in section showing the actuator 38 in a deactivated/extended position (FIG. 3A) and in an activated/compressed position (FIG. 3B). When module 32 is installed within cavity 48, the one end 76 (extending slightly more than other side surfaces) of module 32 adjacent the light source 34 is configured to contact a facing surface 54 of the illuminated portion 16 proximal end 44. At the same time, actuator 38—coupled to and extending from an opposite end of the module 32 from light source 34—contacts an inner wall 52 of the end cap 14.

The end cap 14 and illuminated portion 16 are configured to be moveable relative to one another so as to change an axial length of the cavity 48. When threaded together as shown, rotating the end cap 14 in one direction about the illuminated portion 16 causes the cavity 48 in which module 32 is received to have a decreasing axial length as shown in FIG. 3B. Conversely, rotating end cap 14 in the other direction about illuminated portion 16 causes the cavity to have an increasing axial length as shown in FIG. 3A.

In the embodiment shown, facing surface 54 drives against the body of module 32 and forces actuator 38 to compress against inner wall 52. Actuator 38 may be maintained in this compressed position (FIG. 3B) so long as the end cap is threaded, but may be released to its resting position (FIG. 3A) by counter-rotating the end cap 14 relative to the illuminated portion 16. Preferably, the light source 34 is activated to a lighting function so long as the actuator is in the compressed position, and the light source is deactivated so long as the actuator is in the extended position. Generally, however, the light source 34 is activated when actuator 38 is in one of the extended position or compressed position, and the light source is deactivated when the actuator is in the other of the extended position or compressed position.

Electrical completion of the lighting circuit is done by operation of the actuator 38. Batteries 36 are coupled in series between two terminals 56 and 58. Actuator 38 is in constant electrical contact with terminal 56 via metal plate 60 that bridges across the module 32.

In one embodiment, shown in FIGS. 3A, 3B, and 4, actuator 38 takes the form of a bent flat wire that is flexibly coupled at one end to a terminal of the power source 36. As shown, the actuator 38 is directly connected to metal plate 60 via a metal fold 62 that directs and mechanically biases the actuator away from the surface of the module 32. A second fold or bent portion 64 bends the actuator wire 38 back toward the module surface and terminates in a contact portion 66. Metal folds 62 and 64 give the actuator 38 a spring-like action with a resting position so that contact portion 66 is spaced from electrical contact with terminal 58 as shown in FIG. 3A. As the end cap 14 and illuminated portion 16 are screwed together, however, bent portion 64 of actuator 38 bears against inner wall 52. The compressive force of the inner wall against the actuator 32 overcomes the bias force of the actuator spring to thereby force actuator 38 inward toward the module until the contact portion 66 makes electrical contact with terminal 58 and completes the circuit, thereby lighting LED 34.

The spacing of the contact portion 66 from terminal 58 is preferably linked to the pitch of the threads of threaded portions 42 and 46 so that rotation of the end cap 14 relative to the illuminated portion 16 by less than 90 degrees causes the actuator 38 to move to the compressed position and complete the circuit.

Operation of the actuator completely within cavity 48, and with no external button, has the advantage of simplifying manufacture of the shell of the lighting device as well as protect the module and related electrical components from water intrusion. Further, the lighting device 10 is less likely to be inadvertently activated or deactivated since it is less likely that the end cap would be turned as opposed to an external button accidentally pressed.

Operation of the lighting device 10 according to a preferred embodiment of the invention is illustrated in FIG. 5. With actuator 38 in an extended, deactivated position, no electrical connection is made between terminals 56 and 58 and therefore no energy is available to drive circuit 40 and LED 34. The lighting device 10 is therefore in an ‘off’ position as shown in block 68. As end cap 14 and illuminated portion 16 are twisted together via coupling threads 42, 46, the actuator 38 is forced against an inner wall 52 of the cavity 48 to a compressed position (e.g. FIG. 3B) to complete the circuit and maintain the closed circuit while in the actuator is in this compressed position. Movement of the actuator to the compressed position is detected, as by current flowing to circuit 40, and, responsive to this detection, the light source 34 of the lighting device 10 is activated in a first lighting function for so long as the actuator is in the compressed position. In this example, the first function is a constant light function such that current is supplied to, and LED is illuminated, for so long as actuator 38 contacts terminal 58 and completes the circuit as illustrated in block 70. After illuminating to a first (e.g. constant ‘on’) lighting function, the lighting device may be deactivated by counter-twisting the end cap 14 and illuminated portion relative to one another so that they move apart from one another. Compressive force is thus released from module 32 such that actuator is allowed to move to its extended position (e.g. FIG. 3A) within cavity 48. In this extended position, the contact portion 66 of actuator 38 is spaced from electrical contact with terminal 58. With the electrical connection broken, the light source is deactivated as in block 72. This deactivation is detected as by logic circuit ICs within circuit 40.

Once the end cap 14 and illuminated portion 16 are twisted together a second time, circuit 40 drives the light source 34 to a second function in block 74 as by periodically supplying and then not supplying current to LED 34 to effect a flashing effect. If again the circuit is deactivated, and then reactivated, the function reverts to the first lighting function—e.g. constant ‘on’. The cycle then continues.

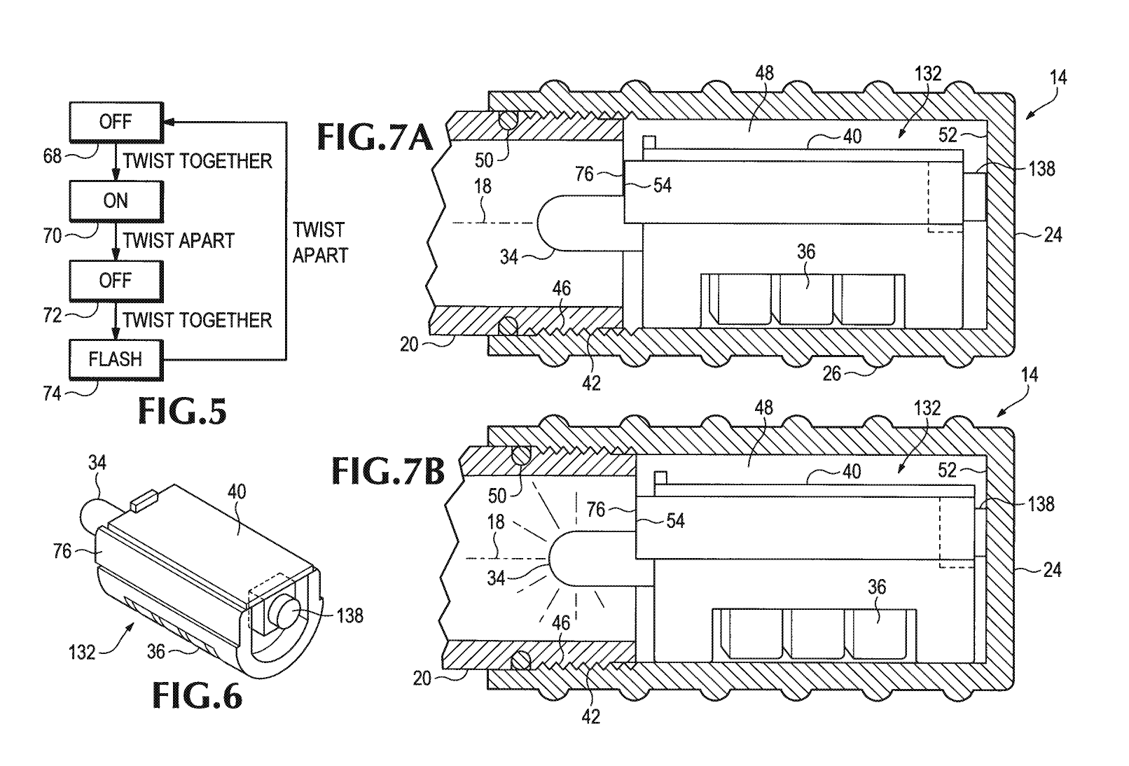

FIGS. 6, 7A and 7B illustrate an alternate embodiment of an actuator 138 shown in button form on module 132. Actuator 138 is of a push-switch type such that the circuit is completed for only so long as the button is compressed (or, alternatively, decompressed). That is, actuator 138 includes a button extending from an end of the module opposite the light source 34 and in a direction parallel to the axis 18 of the illuminated portion 16. The actuator button 138 is configured to contact and bias against an inner wall 52 of the cavity 48 so that movement of the inner wall toward the module causes the button to be compressed to a compressed position and thereby activate the light source. Like components are identically labeled as in FIGS. 3A and 3B.

FIGS. 7A and 7B illustrate side-elevation views of module 132 in section showing the actuator 138 in a deactivated/extended position (FIG. 3A) and in an activated/compressed position (FIG. 7B). When module 132 is installed within cavity 48, the one end 76 of module 132 adjacent the light source 34 is configured to contact a facing surface 54 of the illuminated portion 16 proximal end 44. At the same time, actuator 138—coupled to and extending from an opposite end of the module 132 from light source 34—contacts an inner wall 52 of the end cap 14.

The end cap 14 and illuminated portion 16 are configured to be moveable relative to one another so as to change an axial length of the cavity 48. When threaded together as shown, rotating the end cap 14 in one direction about the illuminated portion 16 causes the cavity 48 in which module 132 is received to have a decreasing axial length as shown in FIG. 7B. Conversely, rotating end cap 14 in the other direction about illuminated portion 16 causes the cavity to have an increasing axial length as shown in FIG. 3A.

In the embodiment shown, facing surface 54 drives against the body of module 132 and forces actuator button 138 to compress against inner wall 52. Button 138 may be maintained in this compressed position (FIG. 7B) so long as the end cap is threaded, but may be released to its resting position (FIG. 7A) by counter-rotating the end cap 14 relative to the illuminated portion 16. Preferably, the light source 34 is activated to a lighting function so long as the actuator is in the compressed position, and the light source is deactivated so long as the actuator is in the extended position. Generally, however, the light source 34 is activated when actuator 138 is in one of the extended position or compressed position, and the light source is deactivated when the actuator is in the other of the extended position or compressed position.

FIG. 8 illustrates an examplary circuit 40 implemented according to a preferred embodiment of the invention. Circuit 40 is electrically coupled between actuator 38 and light source 34 for activating the light to a first (e.g. constant ‘on’) lighting function for so long as the actuator 38 is in a compressed position to effect circuit contact, then detecting the actuator being moved back to a position with no completion of the circuit, and then activating the light to a second (e.g. flashing) lighting function when and for so long as the actuator is moved back to the compressed position.

An examplary circuit 40 includes an integrated circuit 100 programmed and/or hard wired to effect the functions herein described. Circuit 40 can include two RC pairs—e.g. capacitor C1 and resistor R1, and capacitor C2 and resistor R2—for effecting timing for a flashing effect of light source 34 under control of IC 100 in a second lighting function. Circuit 40 can further include a polarity protection means, such as diode D, for protecting the IC 100 in case of reverse bias when the batteries 36 are placed backwards within module 32. Circuit 100 is operative to detect each completion of the electrical circuit and each deactivation so that the circuit 100 can switch between the first lighting function and the second lighting function with successive operations.

Having described and illustrated the principles of the invention in a preferred embodiment thereof, it should be apparent that the invention can be modified in arrangement and detail without departing from such principles. We claim all modifications and variation coming within the spirit and scope of the invention.

What is claimed is:

1. A lighting device comprising:
a module having a light source at one end of the module and a power source;
an actuator biased in an extended position on a surface of the module;
an elongate glow stick housing comprising an end cap and an illuminated portion coupled together to form a cavity, the module received within the cavity so that the light source is directed along an axis of the illuminated portion; and
the end cap and illuminated portion being moveable relative to one another so as to change an axial length of the cavity, a surface of the illuminated portion configured to be moveable against the module so as selectively compress the actuator to a compressed position,
wherein the light source is activated when the actuator is in one of the extended position or compressed position, and the light source is deactivated when the actuator is in the other of the extended position or compressed position.

2. The lighting device of claim 1, wherein the module includes a circuit operative to alternate between a first lighting function and a second lighting function as the light source is activated and then deactivated, and then activated again.

3. The lighting device of claim 2, wherein the first lighting function is activation of the light source to yield a constant light source and the second lighting function is activation of the light source to yield a flashing light source.

4. The lighting device of claim 1, wherein the end cap and illuminated portion are threadedly coupled together so that rotating the end cap in one direction about the illuminated portion causes the cavity in which the module is received to have a decreasing axial length and rotating the end cap in another direction about the illuminated portion causes the cavity to have an increasing axial length.

5. The lighting device of claim 4, wherein the actuator is coupled to and extends from an opposite end of the module from the light source so as to contact an inner wall of the end cap, wherein rotating the end cap in the one direction about the illuminated portion causes the inner wall of the end cap to drive and maintain the actuator to the compressed position.

6. The lighting device of claim 5, wherein rotating the end cap in the other direction allows the actuator to extend to its extended position within the cavity.

7. The lighting device of claim 6, wherein the light source is activated so long as the actuator is in the compressed position and the light source is deactivated so long as the actuator is in the extended position.

8. The lighting device of claim 1, wherein the actuator includes one end flexibly coupled to a terminal of the power source, another end spaced from electrical contact with the light source, and a bent portion located between the one end and other end, the bent portion extending from an end of the module opposite the light source and configured to contact and bias against an inner wall of the cavity so that movement of the inner wall toward the module causes the other end to move into electrical contact with the light source.

9. The lighting device of claim 1, wherein the actuator includes a button extending from an end of the module opposite the light source in a direction parallel to the axis of the illuminated portion and configured to contact and bias against an inner wall of the cavity so that movement of the inner wall toward the module causes the button to be compressed to the compressed position and thereby activate the light source.

10. A lighting device comprising:
an elongate illuminated portion having translucent side walls spaced about a long axis of the illuminated portion;
a light source configured to direct light along a length of the illuminated portion and out the translucent side walls;
an actuator extending in a biased, deactivated position oppositely from the light source; and
a circuit electrically coupled between the actuator and light source for activating the light to a first lighting function for so long as the actuator is moved to a compressed position, detecting the actuator being moved back to its biased position, and activating the light to a second lighting function for so long as the actuator is moved back to the compressed position.

11. The lighting device of claim 10, further including an end cap coupled to the elongate illuminated portion to create a cavity enclosing the light source and actuator, the end cap and illuminated portion being moveable relative to one another along the long axis of the illuminated portion so that a lineal dimension of the cavity can be reduced to thereby cause an inner wall of the cavity to bear against the actuator and move it to the compressed position.

12. The lighting device of claim 11, wherein the end cap and illuminated portion are threadedly coupled together so that rotating the end cap in one direction relative to the illuminated portion causes the cavity in which the module is received to have a decreasing axial length and rotating the end cap in another direction relative to the illuminated portion causes the cavity to have an increasing axial length.

13. The lighting device of claim 12, the actuator being disposed relative to the inner wall of the cavity such that rotation of the end cap relative to the illuminated portion by less than 90 degrees causes the actuator to move to the compressed position.

14. The lighting device of claim 10, wherein the first lighting function is activation of the light source to yield a constant light source and the second lighting function is activation of the light source to yield a flashing light source.

15. A method for operating an electronic glowstick having an elongate illuminated portion coupled along an axial length of the electronic glowstick to an end cap, the method comprising:
installing an integrated module within a cavity formed by the illuminated portion and end cap, the integrated module having a light source at one end directing light along the illuminated portion and an actuator at the other end of the integrated module with a power source located between the light source and actuator;
biasing the actuator in an extended, deactivated position;
forcing the actuator against a wall of the cavity to a compressed position and maintaining the actuator in the compressed position;
responsive to the actuator being forced to the compressed position, activating the light source in a first lighting function for so long as the actuator is in the compressed position;
allowing the actuator to extend to the extended, deactivated position and deactivating the light source.

16. The method of claim 15, further including:
after allowing the actuator to extend to the extended, deactivated position, forcing the actuator against the wall of the cavity to a compressed position and maintaining the actuator in the compressed position a second time; and
responsive to the actuator being forced to the compressed position a second time, activating the light source in a second lighting function for so long as the actuator is in the compressed position.

17. The method of claim 16, wherein the first lighting function is a constant illumination and the second lighting function is a periodic flashing illumination.

18. The method of claim 15, wherein the step of forcing the actuator against the wall of the cavity includes threadedly coupling the illuminated portion and end cap together and decreasing an axial length of the cavity by rotating the end cap in a first direction relative to the illuminated portion.

19. The method of claim 18, wherein the step of allowing the actuator to extend to the extended, deactivated position includes rotating the end cap in a second direction relative to the illuminated portion to thereby increase the axial length of the cavity.

20. A lighting device comprising:
a module having a light source at one end of the module and a power source;
an actuator positioned on a surface of the module opposite the light source for activating the light source;
an elongate glow stick housing comprising an end cap and an illuminated portion coupled together, the module received within the end cap so that the light source is directed along a long axis of the illuminated portion; and
the illuminated portion having translucent side walls spaced about the long axis of the illuminated portion, the side walls proximal to the end cap having a first diameter and the side walls distal to the end cap having a second diameter, wherein the second diameter is less than the first diameter so that the side walls move inwardly toward the long axis of the illuminated portion as they extend from the end cap.
